(19) United States
(12) Patent Application Publication
(10) Pub. No.: US 2025/0179390 A1
(43) Pub. Date: Jun. 5, 2025

(54) SYNERGISTIC COMBINATION OF POLYSACCHARIDE-BASED SURFACTANTS AND BIO-BASED SURFACTANTS

(71) Applicant: Pilot Chemical Corp., West Chester, OH (US)

(72) Inventors: Shoaib Arif, Mason, OH (US); Jeremy Lear, Franklin, OH (US); John Manka, Liberty, OH (US); Angela French, Trenton, OH (US); Glynn Goertzen, Wyoming, OH (US)

(21) Appl. No.: 19/049,070

(22) Filed: Feb. 10, 2025

Related U.S. Application Data
(63) Continuation of application No. PCT/US2023/030057, filed on Aug. 11, 2023.
(60) Provisional application No. 63/397,058, filed on Aug. 11, 2022.

(51) Int. Cl. C11D 1/825; C11D 1/66; C11D 1/83; C11D 1/835; C11D 1/94

(52) U.S. Cl. CPC C11D 1/825; C11D 1/83; C11D 1/835; C11D 1/94; C11D 1/662; C11D 1/667

(57) ABSTRACT

Surfactant blends are disclosed which exhibit improved stability over a wide pH range. The surfactant blends include a polysaccharide-based surfactant and a bio-based surfactant. Methods of making and using the surfactant blends are further provided.

### CROSS-REFERENCE TO RELATED APPLICATIONS

The present application is a continuation of PCT Patent App. No. PCT/US2023/030057, filed Aug. 11, 2023, which claims the priority benefit of U.S. Provisional Patent App. Ser. No. 63/397,058, filed Aug. 11, 2022, each of which are incorporated herein by reference in their respective entireties.

### TECHNICAL FIELD

The present disclosure generally relates to surfactant blends including polysaccharide-based surfactants and bio-based surfactants. The surfactant blends exhibit enhanced stability.

### BACKGROUND

Surfactant blends are compositions formed of a plurality of surfactants. Surfactants and surfactant blends are important components in many formulations acting as a detergent, cleaning agent, wetting agent, emulsifier, foaming agent, or dispersant in numerous products including household, industrial, and institutional products, personal and home care compositions, and various industrial processes such as oil field and oil production processes. The properties of the surfactant or surfactant blend are important in determining the specific use cases.

### BRIEF DESCRIPTION OF THE DRAWINGS

FIG. 1 depicts a photograph of a polysaccharide surfactant at various pH conditions.

FIG. 2 depicts a photograph of a second polysaccharides surfactant at various pH conditions.

FIG. 3 depicts a photograph of a surfactant blend including a polysaccharide surfactant and a bio-based surfactant at various pH conditions.

FIG. 4 depicts a photograph of a surfactant blend including a polysaccharide surfactant, a bio-based surfactant, and a sophorolipid surfactant at various pH conditions.

FIGS. 5 to 9 depict a series of photographs showing the stability of a polysaccharide surfactant and a bio-based surfactant at various pH conditions as the ratio of the polysaccharide surfactant and the bio-based surfactant are varied.

### DETAILED DESCRIPTION

The present application describes novel surfactant blends which exhibit unexpected stability over a wide pH range and which are biologically-derived and environmentally friendly. Generally, the surfactant blends described herein can include at least a polysaccharide-based surfactant and a bio-based surfactant. The polysaccharide-based surfactant can include a dextrin or dextran compound such as maltodextrin. The bio-based surfactant can be an alkylpolyglucoside, a rhamnolipid, or a sophorolipid. The surfactant blends can exhibit greater stability than any of the individual surfactants alone. As used herein, stability refers to the surfactant blend maintaining a stable clear aqueous solution over a pH range of about 3 to about 11 including a pH range of about 5 to about 11 and a temperature range varying from about 0° C. to about 60° C. including a temperature range of about 23° C. to about 50° C. in various embodiments.

As can be appreciated, polysaccharide-based surfactants can exhibit or suffer various problems when combined with other surfactants or solvents. For example, compositions including polysaccharide-based surfactants can exhibit miscibility, compatibility, and solubility issues as evidenced by the formation of biphasic aqueous solutions when combined with other surfactants or even alone. As can be appreciated, clear aqueous solutions are a sign of stability and are particularly preferred for applications such as personal and home care products where consumers desire clear products as opposed to translucent or opaque products.

Without being bound by theory, it is believed that the surfactant blends described herein exhibit unexpected stability due to one or more of compatibilization between the component surfactants and shielding interactions between the surfactants.

Compatibilization is an interfacial phenomenon observed in heterogeneous solutions or blends. Specifically, compatibilization is a process by which blend properties are enhanced due to increased interaction between the phases which reduces the interfacial tension and stabilizes the mixture. Compatibilization is an effective way to adjust the properties and to manipulate the morphology of immiscible components.

For the disclosed surfactant blends, compatibilization is believed to occur due to interactions with the saccharide head groups of the polysaccharide-based surfactants which can interact with all of the surfactants in the blend. Compatibilization may also be due to resultant micelles that are more efficiently stabilized by the mixed polysaccharide surfactants versus micelles made from conventional surfactants. It is known by those skilled in the art, that mixtures of surfactants can yield synergistic properties that arise from modifying the micellular structure. Mixtures of surfactants can yield a different packing of the surfactants at the micelle interface which results in different micellular structures and physical properties as compared to the same system employing only one type of conventional surfactant.

In addition to compatibilization, it is theorized that shielding can also enhance the compatibility of the polysaccharide-based surfactants through combination with other bio-based surfactants. As can be appreciated, surfactants can interact through various nonbonding interactions such as dipole-dipole interactions and hydrogen bonding. These nonbonding interactions can be especially susceptible to solution ionic strength and pH. Polysaccharide-based surfactants (with multiple groups capable of dipole interactions and hydrogen bonding) have more potential than traditional surfactants (typically with only one, or few groups, capable of dipole interactions or hydrogen bonding) to be affected by ionic strength and pH due to the larger numbers of groups present for dipole and hydrogen bond formation.

The synergistic interaction between the different polysaccharide head groups of the various saccharide-based surfactants is believed to be caused by the polar groups that can interact with the similar groups on different saccharide surfactants and other bio-based surfactants. This interaction is believed to prevent, preclude, or lessen the propensity for the saccharide head groups from interacting with the ionic species in the solution thus increasing stability, clarity, and performance. As surfactants interact through nonbonding interactions such as dipole-dipole interactions and hydrogen bonding, polysaccharide-based surfactants can have greater mutual miscibility than traditional surfactants due to the larger number of groups available for dipole and hydrogen bonding. The properties of the surfactant blends described herein can show a synergistic improvement over the properties of the component surfactants which are not stable at pHs lower than about pH 1 and greater than about pH 12.

The surfactant blends described herein exhibit unexpected pH and hydrolytic stability. Specifically, low rates of hydrolysis were observed at both low and high pH with the blends maintaining a clear aqueous solution. The individual surfactants alone did not exhibit such pH and hydrolytic stability as they were observed to separate into distinct immiscible layers and/or yield a hazy or cloudy aqueous solution that was unstable at both low and high pH. Although the polysaccharide-based surfactants with HLB lower than about 19 are only marginally water soluble and exhibit non-homogenous bilayers or cloudy aqueous solutions, the surfactant blends described herein exhibit a clear aqueous homogenous solution when blended with water at various pH values demonstrating the stability of the blends. As can be appreciated, clarity is vital for both critical to operation of certain compositions and highly desirable for personal and home care compositions.

In certain embodiments, suitable polysaccharide-based surfactants can vary in form. For example, suitable polysaccharide-based surfactants can include surfactants formed of various pyranose-type polysaccharides and furanose-based polysaccharides including α-and β-D-Galactopyranosyl (α,βGalp), 3,6-Anhydro α-D-Galactopyranosyl (αGalp3,6AN), β-D-Mannopyranosyl (βManp), β-D-Mannopyranosyluronic acid (βManpA), α-D-Galctopyranosyluronic acid (αGalpA), β-D-Glucopyranosyluronic acid (βGlcpA), α-L-Glucopyranosyluronic acid (αLGulpA), α-L-Rhamnopyranosyl (αLRhap), β-D-Xylopyranosyl (βXylp), and α-L-Arabinofuranosyl (αLAraf) in various embodiments.

Examples of suitable polysaccharides rings that can be used to form polysaccharide-based surfactants can include:

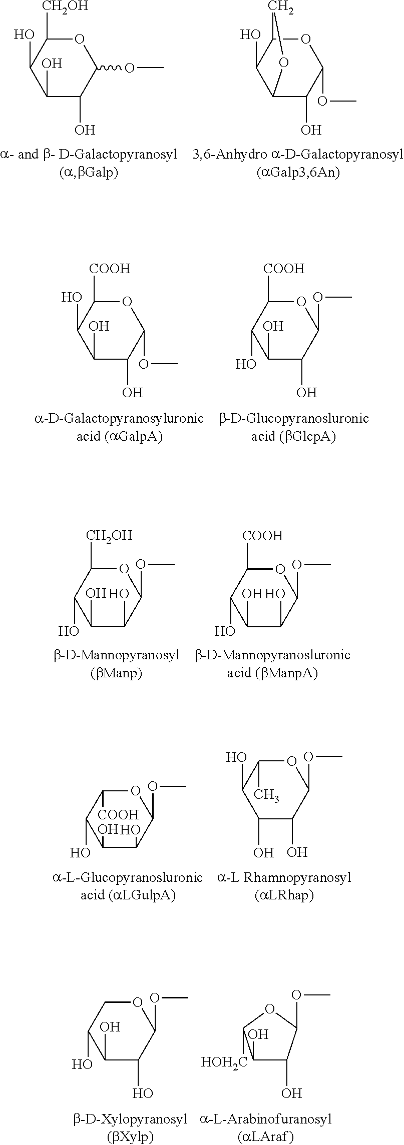

In certain embodiments, the polysaccharide-based surfactant can comprise dextran, dextrin or related compounds. For example, in certain embodiments, the polysaccharide-based surfactant can be a maltodextrin surfactant. In certain such embodiments, the maltodextrin surfactant can have a dextrose equivalent of between about 2 to about 25 including values between about 3 and about 25 such as about 4.5 to about 6.0, or about 9.0 to about 12.0. At least a portion of the sugar monomers may form a reaction product upon being contacted under suitable conditions with a fatty acid salt, such as a salt of a C4-C30 fatty acid or a C4-C20 fatty acid. Without being limited by theory, at least a portion of the sugar monomers may react to form a fatty ester of the polysaccharide compound in some embodiments, optionally present in combination with unreacted fatty acid salt in an aqueous phase. When formed, an ester reaction product may form at any hydroxyl group of the dextrin compound, including any combination of primary and/or secondary hydroxyl groups. Hydroxyl groups upon the neutral surfactant may undergo a reaction under similar conditions.

In certain embodiments, suitable polysaccharide-based surfactants can be commercially obtained. For example, suitable polysaccharide-based surfactants can include Tegrasurf® 70, Tegrasurf® 90, Tegrasurf® 120, Tegrasurf® 126, Tegrasurf® 160, Tegrasurf® 166, Tegrasurf® 190, and Tegrasurf® 196 each available from Integrity Bio-Chemicals, LLC (Cresson, TX). In certain embodiments, the polysaccharide-based surfactants can be formed from natural products and can include a blend of surfactants each derived from different sugars.

Suitable bio-based surfactants can include alkylpolyglucoside surfactants, rhamnolipid surfactants, and sophorolipid surfactants. In certain embodiments, a bio-based surfactant can be an alkylpolyglucoside surfactant such as a C8-C10 alkyl polyglucoside. As can be appreciated, suitable bio-based surfactants can be commercially obtained. For example, in certain embodiments, the bio-based surfactant can be a C8-C10 alkyl polyglucoside such as Masopon® 215 marketed by the Pilot Chemical Co. (Mason, OH) or Sucranov 810P marketed by Jarchem Innovative Ingredients (Newark, NJ). Other examples of suitable bio-based surfactants can include Amphi M marketed by Locus (Cleveland, OH), Rewoferm SL One marketed by Evonik Industries AG (Essen, DE) (a sophorolipid surfactant) and Jeneil JBR 425 marketed by Jeneil Biotech Inc. (Saukville, WI) (a blend of mono and dirhamnolipid surfactants).

To adjust the properties of the surfactant blend for various applications, the surfactant blend can include additional components in various embodiments. For example, additional bio-based surfactants can be included in certain embodiments. Additionally, or alternatively, other additives, surfactants and hydrotropes including nonionic, anionic, zwitterionic or amphoteric and cationic surfactants can be included in certain embodiments.

Generally, such additional surfactants can be any known surfactants that do not interfere with the stability of the primary polysaccharide-based surfactants and the bio-based surfactant. For example, suitable anionic surfactants can include sulfonic acid based surfactants such as alkylbenzene sulfonic acids, sulfates, phosphates, carboxylates, sulfosuccinates, and salts thereof. Suitable nonionic surfactants can include ethoxylates, polysaccharides, and alcohol surfactants. Suitable cationic surfactants can include quaternary ammonium salts, betaines, amidobetaines, and sultaines. Suitable hydrotropes can include any known hydrotropes including sodium xylene sulfonates, betaines, hydroxy sultaines, sulfonate proprionates, diproprionates, various organic acids, alkanoates, phosphate esters, and functionalized alkylpolyglycosides. Suitable zwitterionic or amphoteric surfactants can include amine oxide surfactants such as Caloxamine® CPO, aloxamine® LO, Macat® AO-8, Macat® AO-10, Macat® AO-12, Macat® AO-14, Macat® AO-12-2, Macat® AO-11:2, Macat® MCO, Macat® Ultra LMDO, and Macat® Ultra CDO each marketed by the Pilot Chemical Co. (Mason, OH).

Inclusion of non-bio-based, conventional surfactants (such as sodium lauryl sulfate, alpha olefin sulfonate, propylene glycol and ethylene glycol hydrotropes) may not improve the pH or storage stability of the disclosed surfactant blends or stability of any of the individual surfactants of the surfactant blends. As can be appreciated however, inclusion of non-bio-based conventional surfactants can be useful to add additional benefits and tailor the properties of the surfactant blend (e.g., to improve surfactant performance, foam generation, etc.). In certain embodiments, it can also be useful to forego inclusion of any non-bio-based surfactants as such surfactant blends would exhibit high environmental sustainability.

In certain embodiments, the surfactant blend can include the polysaccharide-based surfactant and the bio-based surfactant in an about 1:3 to about 3:1 ratio. In certain embodiments, the ratio of the polysaccharide-based surfactant and the bio-based surfactant can be included in an about 1:1 ratio. In certain embodiments, the polysaccharide-based surfactant and the bio-based surfactant can comprise the majority, by weight, of the surfactant blend. For example, in certain embodiments, the polysaccharide-based surfactant and the bio-based surfactant can be about 50%, by weight, of the surfactant blend, with the remainder constituting other surfactants or hydrotropes. In certain embodiments, the polysaccharide-based surfactant and the bio-based surfactant can comprise substantially 100%, by weight of the surfactant blend. For example, in certain embodiments, the polysaccharide-based surfactant and the bio-based surfactant can comprise about 97%, by weight, of the surfactant blend.

Generally, the surfactant blends described herein can be formed as known in the art. For example, each of the surfactants can be combined and then mixed together using a blender or other mixing equipment. Once formed, the surfactant blends can be stored in a suitable container such as a plastic, glass, or metal container. As can be appreciated, the stability of the surfactant blends can provide a long shelf life to the blends.

### Examples

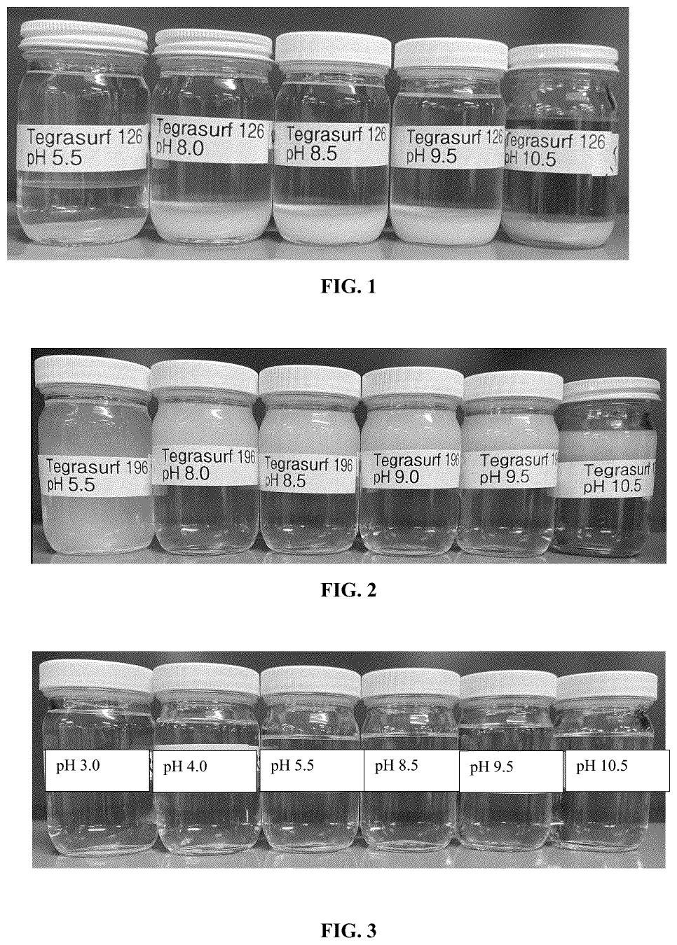

To evaluate the stability of polysaccharide-based surfactants, various polysaccharide-based surfactants were dissolved with a pH additive and preservative and allowed to rest for 24 hours. Samples were considered unstable if the surfactant separated into a biphasic or cloudy solution within 24 hours. The formulations and results are depicted in Table 1. Photos of the testing are depicted in FIGS. 1 and 2.

TABLE 1

| | Tegrasurf ® | Tegrasurf ® | | | |
|---|---|---|---|---|---|
| Formulations | 126 (%) | 196 (%) | Preservative/% | pH/additive | Stability |
| 1 | 99.5 | — | Sodium | 5.09/Citric | Unstable. Separated |
| | | | Benzoate/0.5 | Acid. | within 24 hours at room |
| | | | | | temperature. |
| 2 | — | 99.5 | Sodium | 5.16/Citric | Unstable. Separated |
| | | | Benzoate/0.5 | Acid | within 24 hours at room |
| | | | | | temperature. |
| 3 | 100 | — | High pH | 10.53/KOH | Unstable. Separated |
| | | | | 45% | within 24 hours at room |
| | | | | | temperature. |
| 4 | — | 100 | High pH | 10.50/KOH | Unstable. Separated |
| | | | | 45% | within 24 hours at room |
| | | | | | temperature. |
| 5 | 100 | — | High pH | 11.19/KOH | Unstable. Separated |
| | | | | 45% | within 24 hours at room |
| | | | | | temperature. |
| 6 | — | 100 | High pH | 10.98/KOH | Unstable. Separated |
| | | | | 45% | within 24 hours at room |
| | | | | | temperature. |
| 7 | 99.0 | — | Sodium. | 5.18/Citric | Unstable. Separated |
| | | | Benzoate. & | Acid | within 24 hours at room |
| | | | Potassium | | temperature. |
| | | | Sorbate | | |
| | | | (Microcare SB)/1.0 | | |
| 8 | — | 99.0 | Sodium. | 5.18/Citric | Unstable. Separated |
| | | | Benzoate. & | Acid | within 24 hours at room |
| | | | Potassium | | temperature. |
| | | | Sorbate | | |
| | | | (Microcare SB)/1.0 | | |
| 9 | 99.9 | — | MCI/MI | 7.3 | Stable for 24 hours |
| | | | (Microcare ITL) | | |
| 10 | — | 99.9 | MCI/MI | 6.79 | Stable for 24 hours |
| | | | (Microcare ITL) | | |

As depicted in Table 1, the polysaccharide-based surfactants were unstable under both acidic and basic conditions with only neutral pH formulations (Formulations 9 and 10) remaining stable after 24 hours.

To further evaluate the stability of polysaccharide-based surfactants, further samples of pure polysaccharide-based surfactants were stored for one month at both room temperature and at various pH levels. Additionally, Inventive Example 1 was further evaluated in the same test. Inventive Example 1 is a 50:50 blend of a polysaccharide-based surfactant (Tegrasurf® 196) and a 60% active C8-C10 alkyl polyglucoside. The results of the stability testing are depicted in Table 2. A photo of Inventive Example 1 being evaluated at different pH levels is depicted in FIG. 3.

TABLE 2

| | | | | | Inventive | |
|---|---|---|---|---|---|---|
| | | | | | Example 1 - | Inventive |
| | | | | | 50:50 | Example 2 |
| | | | | | Blend | 50:50 |
| | | | | | Tegrasurf ® | Blend |
| | | | | | 196 + | Tegrasurf ® |
| | Tegrasurf ® | | Tegrasurf ® | | Masopon ® | 196 + |
| | 126 | Tegrasurf ® | 196 | Tegrasurf ® | 215 | Masopon ® |
| | Room | 126 | Room | 196 | Room | 215 |
| pH | Temp. | 50° C | Temp. | 50° C | Temp. | 50° C |
| 5.0 | Separates | Separates | Separates | Separates | Stable | Stable |
| 6.0 | Stable | Separates | Stable | Separates | Stable | Stable |
| 7.0 | Stable | Stable | Stable | Stable | Stable | Stable |
| 8.0 | Separates | Separates | Separates | Separates | Stable | Stable |
| 9.0 | Separates | Separates | Separates | Separates | Stable | Stable |
| 10.0 | Separates | Separates | Separates | Separates | Stable | Stable |
| 11.0 | Separates | Separates | Separates | Separates | Stable | Stable |

As depicted in Table 2, the only polysaccharide-based surfactants that remained stable for an entire month were samples maintained at a neutral pH. All other samples separated into an undesirable biphasic solution demonstrating instability. In contrast, combination of the same polysaccharide-based polymer in a 1:1 ratio with an alkylpolyglycoside surfactant maintained stability over the entire pH range and temperature range.

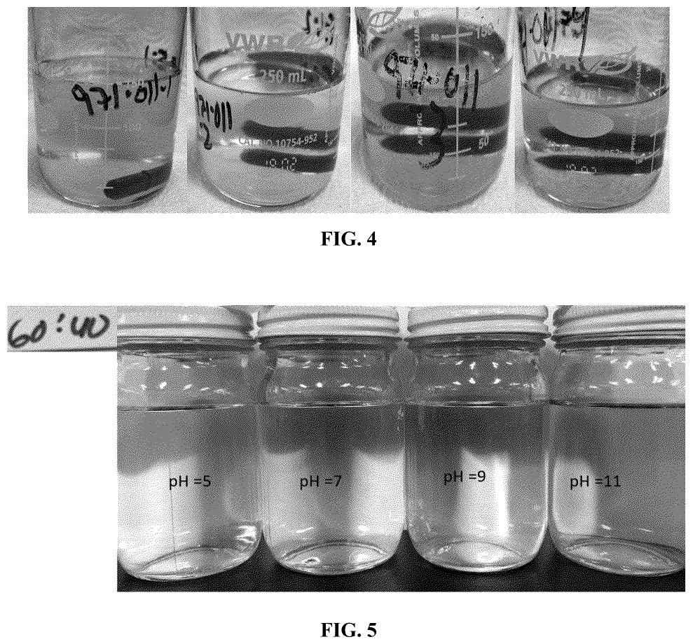

Inventive Examples 2 and 3 were evaluated similarly to Inventive Example 1 and demonstrated the same stability. In addition to the stability of Inventive Example 1, Inventive Examples 2 and 3 further demonstrated advantageous properties as depicted in Table 4. The formulations of Inventive Examples 2 and 3 are depicted in Table 3 and the properties in Table 4. A photo demonstrating the stability of Inventive Example 2 is further depicted in FIG. 4. RCI is the renewable carbon index and indicates the sustainability of the surfactant blend.

TABLE 3

| | Inventive | Inventive |
|---|---|---|
| Component | Example 2 | Example 3 |
| Commercial Polysaccharide- | 48.5 (% w/w) | — |
| Based Surfactant (Tegrasurf ® | | |
| 196) | | |
| Commercial Polysaccharide- | — | 48.5 (% w/w) |
| Based Surfactant (Tegrasurf ® | | |
| 190) | | |
| Biobased Surfactant (C8-C10 | 48.5 (% w/w) | 48.5 (% w/w) |
| Alkyl Polyglucoside, 60% | | |
| active) | | |
| Commercial Sophorolipid | 3.0 (% w/w) | 3.0 (% w/w) |
| Surfactant (Amphi ™ M) | | |

TABLE 4

| | Inventive | Inventive |
|---|---|---|
| Property | Example 2 | Example 3 |
| Appearance | Clear Liquid | Clear Liquid |
| RCI | 89.1 | 96.2 |
| % Active | 44.0 | 44.8 |
| pH | 7.0 | 7.0 |
| Viscosity (at 25° C.) | 50 cp. | 50 cp. |
| Form (Initial, After 5 Minutes) | 173, 168 | 173, 170 |
| Surface Tension | 28.7 | 29.0 |
| Wetting Time | Instant | Instant |

As depicted in Tables 3 and 4 and FIG. 4, Inventive Examples 2 and 3 exhibited desirable stability and properties.

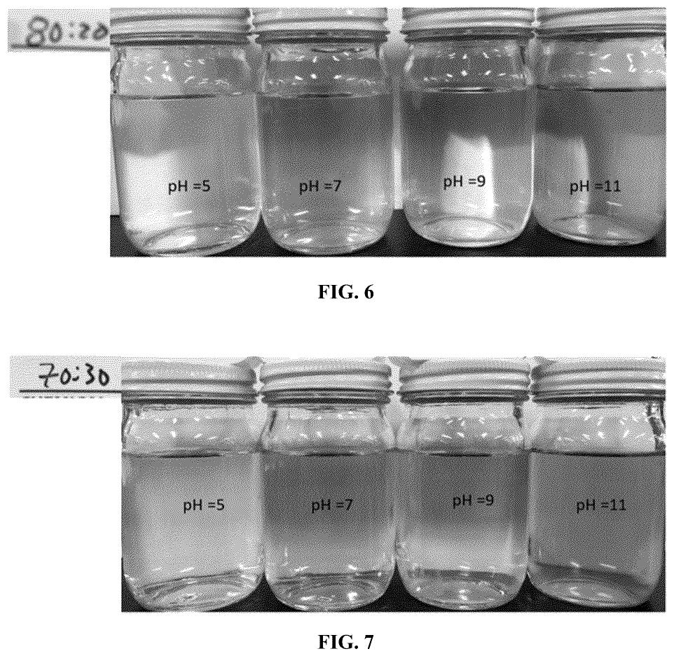

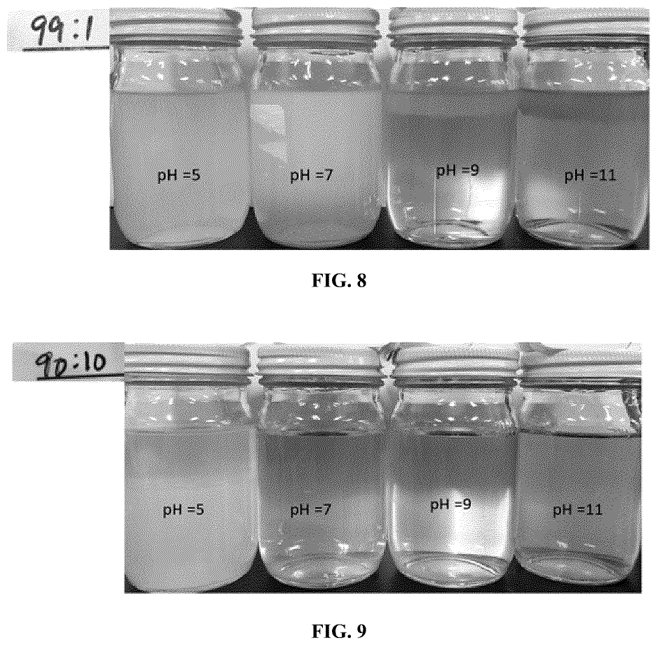

FIGS. 5 to 9 depict further surfactant blends having varying ratios of a commercial polysaccharide-based surfactant (Tegrasurf® 196) and a 60% active C8-C10 alkyl polyglucoside. FIG. 5 has a ratio of 60:40; FIG. 6 has a ratio of 80:20; FIG. 7 has a ratio of 70:30; FIG. 8 has a ratio of 99:1; and FIG. 9 has a ratio of 90:10.

As depicted in FIGS. 5 to 9, ratios of polysaccharide-based surfactant to alkyl polyglucoside of about 70:30 to about 50:50 demonstrated stability over a wide pH range while samples having a greater than 70:30 ratio (e.g., FIGS. 8 and 9 at 99:1 and 90:10 respectively) demonstrated instability at pH 5 (FIG. 9 at a ratio of 90:10) and at all pH values except neutral at a ratio of 99:1.

Table 5 depicts further Inventive Examples 4 to 9. Inventive Examples 4 to 9 differ from the earlier inventive examples by being formed of a polysaccharide-based surfactant (Tegrasurf® 196), a polysaccharide-based surfactant (Tegrasurf® 190), an alkyl polyglucoside (C8-C10 Alkyl Polyglucoside, 60% active), a sophorolipid surfactant (AMPHI M marketed by Locus (Cleveland, OH), a sophorolipid surfactant (Rewoferm SL One) marketed by Evonik Industries AG (Essen, DE), and a blend of mono and dirhamnolipid surfactants (Jeneil JBR 425 marketed by Jeneil Biotech Inc. (Saukville, WI). The weight percentage of Inventive Examples 4 to 9 are depicted in Table 5.

TABLE 5

| | Inventive | Inventive | Inventive | Inventive | Inventive | Inventive |
|---|---|---|---|---|---|---|
| Component | Example 4 | Example 5 | Example 6 | Example 7 | Example 8 | Example 9 |
| Commercial | 33.2 | 45.0 | 44.9 | 44.3 | 48.5 | — |
| Polysaccharide- | | | | | | |
| Based Surfactant | | | | | | |
| (Tegrasurf ® 196) | | | | | | |
| Commercial | — | — | — | — | — | 48.5 |
| Polysaccharide- | | | | | | |
| Based Surfactant | | | | | | |
| (Tegrasurf ® 190) | | | | | | |
| Biobased | 33.2 | 45.3 | 45.5 | 45.1 | 48.5 | 48.5 |
| Surfactant | | | | | | |
| (C8-C10 Alkyl | | | | | | |
| Polyglucoside, | | | | | | |
| 60% active) | | | | | | |
| Sophorolipid | 33.6 | 9.7 | — | 5.4 | — | — |
| Surfactant | | | | | | |
| (Rewoferm SL One) | | | | | | |
| Blend of Mono and | — | — | 9.6% | 5.3 | — | — |
| Dirhamnolipid | | | | | | |
| Surfactants | | | | | | |
| (Jeneil JBR 425 | | | | | | |
| Commercial | — | — | — | — | 3.0 | 3.0 |
| Sophorolipid | | | | | | |
| Based Surfactant | | | | | | |
| (AMPHI ® M) | | | | | | |
| Weight | 46.5% | 43.9% | 41.8% | 42.8% | 40.6% | 40.3% |
| Percentage | | | | | | |
| Active | | | | | | |

Inventive Examples 4 to 9 were formulated into all-purpose cleaners through incorporation of water, sodium carbonate, D-limonene, and methylchloroisothiazolinone/methylisothiazolinone (“MCI/MI”) preservative. The formulation is depicted in Table 6.

TABLE 6

| | Cleaning |
|---|---|
| Component | Formulation |
| Water | Remainder |
| Surfactant Blend | 1.0% active |
| | (from Table 5) |
| Sodium Carbonate | 0.5% |
| D-limonene | 0.2% |
| MCI/MI | 0.1% |

The all-purpose cleaners formed were evaluated using the standardized All-Purpose Cleaning Performance Testing (A6 Soil) delineated in ASTM Standard D4488. The all-purpose cleaners were evaluated against Method All-Purpose Cleaner marketed by Method Products, PBC (San Francisco, CA) and Lemi-Shine (Envirocon Technologies, Inc. (Austin, TX) The results are depicted in Table 7.

TABLE 7

| | ASTM D4488 |
|---|---|
| Cleaning | (A6 Soil) |
| Composition | Cleaning Result |
| Cleaning | 60.8% |
| Composition using | |
| Inventive Example 4 | |
| Cleaning | 62.9% |
| Composition using | |
| Inventive Example 5 | |
| Cleaning | 70.7% |
| Composition using | |
| Inventive Example 6 | |
| Cleaning | 67.6% |
| Composition using | |
| Inventive Example 7 | |
| Cleaning | 90.6% |
| Composition using | |
| Inventive Example 8 | |
| Cleaning | 91.8% |
| Composition using | |
| Inventive Example 9 | |
| Commercial | 71.5% |
| Cleaning | |
| Composition | |
| (Method All-Purpose | |
| Cleaner) | |
| Commercial | 42.8% |
| Cleaning | |
| Composition (Lemi- | |
| Shine) | |

As depicted in Table 7, the cleaning compositions formed of Inventive Examples 4 to 9 demonstrated comparable cleaning performance to a conventionally formulated commercial all-purpose cleaner and superior results to an environmentally friendly commercial all-purpose cleaner. The cleaning compositions formed of Inventive Examples 4 to 9 include only biologically derived surfactants.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. Certain embodiments disclosed herein can be combined with other embodiments as would be understood by one skilled in the art. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A surfactant blend composition comprising:
a dextran-based polysaccharide surfactant or dextrin-based polysaccharide surfactant; and
a bio-based surfactant comprising one or more of an alkylpolyglucoside based surfactant, a rhamnolipid surfactant, and a sophorolipid surfactant.

2. The surfactant blend composition of claim 1, wherein the dextrin-based polysaccharide surfactant comprises a maltodextrin.

3. The surfactant blend composition of claim 2, wherein the maltodextrin has a dextrose equivalent value of about 3 to about 25.

4. The surfactant blend composition of claim 2, wherein the maltodextrin has a dextrose equivalent value of about 4.5 to about 7.0.

5. The surfactant blend composition of claim 2, wherein the maltodextrin has a dextrose equivalent value of about 9.0 to about 12.0.

6. The surfactant blend composition of claim 1, wherein at least a portion of the dextran-based polysaccharide surfactant or the dextrin-based polysaccharide surfactant is formed as a reaction product of a polysaccharide and a fatty acid or fatty acid salt.

7. The surfactant blend of claim 6, wherein the fatty acid or fatty acid salt comprises a C4-C20 fatty acid or C4-C20 fatty acid salt.

8. The surfactant blend composition of claim 1, wherein the bio-based surfactant comprises an alkylpolyglucoside based surfactant.

9. The surfactant blend composition of claim 1, wherein the bio-based surfactant comprises a rhamnolipid surfactant.

10. The surfactant blend composition of claim 1, wherein the bio-based surfactant comprises a sophorolipid surfactant.

11. The surfactant blend composition of claim 1 further comprises one or more additional surfactants and hydrotropes.

12. The surfactant blend composition of claim 11, wherein the additional surfactants comprise polysaccharide, nonionic, anionic, zwitterionic, amphoteric, or cationic surfactants.

13. The surfactant blend composition of claim 12, wherein the anionic surfactant comprises a sulfonic acid-based surfactant.

14. The surfactant blend composition of claim 13, wherein the sulfonic acid-based surfactant comprises an alkylbenzene sulfonic acid salt, a sulfate, a phosphate, or a carboxylate.

15. The surfactant blend composition of claim 12, wherein the cationic surfactant comprises a quaternary ammonium salt, a betaine, or a sultane.

16. The surfactant blend composition of claim 12, wherein the nonionic surfactant comprises an ethoxylate, a polysaccharide, or an alcohol.

17. The surfactant blend composition of claim 12, wherein the zwitterionic, amphoteric surfactant comprises a phospholipid, an amidobetaine, a lauryldimethylamine N-oxide, or a lecithin.

18. The surfactant blend composition of claim 11, wherein the hydrotropes comprise sodium xylene sulfonates, betaines and hydroxy sultaines/sulfonates proprionates, diproprionates, organic acids, alkanoates, phosphate esters and functionalized alkylpolyglucosides.

19. A personal care product, a household cleaning product, a laundry care product, or an oilfield production surfactant product comprising the surfactant blend composition of claim 1.
